(19) United States
(12) Patent Application Publication
(10) Pub. No.: US 2019/0384806 A1
(43) Pub. Date: Dec. 19, 2019

(54) PER-WEB-PAGE TIME ZONE

(71) Applicant: Microsoft Technology Licensing, LLC, Redmond, WA (US)

(72) Inventor: Fabio Andre Pintos, Kirkland, WA (US)

(21) Appl. No.: 16/010,077

(22) Filed: Jun. 15, 2018

(51) Int. Cl. G06F 17/22; G06F 17/30

(52) U.S. Cl. CPC G06F 17/2247; G06F 17/30899; G06F 17/3089

(57) ABSTRACT

Methods, systems, and apparatuses for providing a per-web-page time zone. One apparatus includes a memory storing a local time zone and at least one electronic processor. The at least one electronic processor is configured to execute a browser application to read a time zone value included in a web page to be displayed within the browser application, wherein the time zone value specifies a time zone different than the local time zone. The at least one electronic processor is also configured to apply the time zone specified by the time zone value in place of the local time zone for a time-related command included in the web page executed by the browser application without changing the local time zone to the time zone value included in the web page.

### FIELD

Embodiments described herein relate to systems and methods for providing a per-web-page time zone, such that time-related commands included in a web page can be performed with respect to a time zone that may differ from the time zone of the browser application displaying the web page or the time zone of the computing device executing the browser application.

### SUMMARY

Web pages often display dates and times, and interactive web pages may receive and process dates and times from users. The dates and times, however, are typically processed using a time zone of the browser application, which is often defined by the operating system of the computing device executing the browser application. Accordingly, commands included a web page that parse and format dates and times, such as converting such data to a string, apply the local time zone of the browser application, which is often set based on the geographical location of the computing device executing the browser application.

In some situations, adopting the local time zone of the browser application by a web page makes sense. However, in other situations, a user may want to use a time zone for a web page that differs from the current local time zone of the computing device and the associated browser application. For example, a user may reside in a first time zone but may currently be on a trip to a location in a second, different time zone. While on the trip, the user may receive a request to schedule a meeting for the following week when the user will be back in the first time zone. In this situation, when the user views his or her calendar via a web-based calendaring application, such as Outlook® provided by Microsoft Corporation, the user's schedule for next week may be displayed for the second time zone because this the user's current time zone. Thus, the user may have difficulty scheduling a meeting within his or her calendar for the following week because the calendar for that week is not provided in the relevant time zone for the meeting.

To modify the time zone used by a web page, the user may manually adjust the time zone of the operating system or the browser application. However, this manual change can cause issues for other applications executed by the computing device (including other web pages) that rely on an accurate time for the current time zone. Similarly, when the user is using a kiosk or other shared computing device, changing the time zone may negatively affect other users. Additionally, a web page may rely on a server to convert dates and times to a desired time zone but this solution increases the number of calls to the server and the bandwidth used by a user device. Similarly, the web page can be written to parse and format time-related data in a user-specified time zone, but this additional logic increases the complexity and likelihood of bugs or errors in the web page.

Accordingly, embodiments described herein provide systems and methods for providing a per-web-page time zone that may differ from the local time zone of the browser application displaying the web page or the computing device (operating system) executing the browser application. After a time zone is set for a particular web page, the web page can continue to leverage defined time-related commands to parse and format dates and times without requiring additional logic within the web page.

For example, one embodiment provides an apparatus for providing a per-web-page time zone. The apparatus includes a memory storing a local time zone and at least one electronic processor. The at least one electronic processor is configured to execute a browser application to read a time zone value included in a web page to be displayed within the browser application, wherein the time zone value specifies a time zone different than the local time zone. The at least one electronic processor is also configured to apply the time zone specified by the time zone value in place of the local time zone for a time-related command included in the web page executed by the browser application without changing the local time zone to the time zone value included in the web page.

Another embodiment provides a method of providing a per-web-page time zone. The method includes reading, with at least one electronic processor, a time zone value included in a first web page to be displayed within a browser application, wherein the time zone value specifies a time zone different than a local time zone of the browser application. The method also includes applying, with the at least one electronic processor, the time zone specified by the time zone value in place of the local time zone for a time-related command included within the first web page executed by the browser application without changing the local time zone of the browser application to the time zone value included in the first web page, and applying, with the at least one electronic processor, the local time zone for a time-related command included within a second web page executed by the browser application when the second web page does not include the time zone value.

Yet another embodiment provides a non-transitory computer-readable medium including instructions executable by an electronic processor to perform a set of functions. The set of functions includes reading a time zone value included in a first web page to be displayed within a browser application, the time zone value specifying a time zone different than a local time zone. The set of functions also includes applying the time zone specified by the time zone value in place of the local time zone for a time-related command within the first web page executed by the browser application without changing the local time zone to the time zone value included in the first web page, and applying the local time zone for a time-related command included within a second web page executed by the browser application when the second web page does not include the time zone value.

### BRIEF DESCRIPTION OF THE DRAWINGS

FIG. 1 schematically illustrates a system for displaying a web page according to some embodiments.

FIG. 2 schematically illustrates a user device included in the system of FIG. 1 according to some embodiments.

FIG. 3 is a flowchart illustrating a method of providing a per-web-page time zone performed by the user device of FIG. 2 according to some embodiments.

### DETAILED DESCRIPTION

One or more embodiments are described and illustrated in the following description and accompanying drawings. These embodiments are not limited to the specific details provided herein and may be modified in various ways. Furthermore, other embodiments may exist that are not described herein. Also, the functionality described herein as being performed by one component may be performed by multiple components in a distributed manner. Likewise, functionality performed by multiple components may be consolidated and performed by a single component. Similarly, a component described as performing particular functionality may also perform additional functionality not described herein. For example, a device or structure that is “configured” in a certain way is configured in at least that way, but may also be configured in ways that are not listed. Furthermore, some embodiments described herein may include one or more electronic processors configured to perform the described functionality by executing instructions stored in non-transitory, computer-readable medium. Similarly, embodiments described herein may be implemented as non-transitory, computer-readable medium storing instructions executable by one or more electronic processors to perform the described functionality. As used in the present application, “non-transitory computer-readable medium” comprises all computer-readable media but does not consist of a transitory, propagating signal. Accordingly, non-transitory computer-readable medium may include, for example, a hard disk, a CD-ROM, an optical storage device, a magnetic storage device, a ROM (Read Only Memory), a RAM (Random Access Memory), register memory, a processor cache, or any combination thereof.

In addition, the phraseology and terminology used herein is for the purpose of description and should not be regarded as limiting. For example, the use of “including,” “containing,” “comprising,” “having,” and variations thereof herein is meant to encompass the items listed thereafter and equivalents thereof as well as additional items. The terms “connected” and “coupled” are used broadly and encompass both direct and indirect connecting and coupling. Further, “connected” and “coupled” are not restricted to physical or mechanical connections or couplings and can include electrical connections or couplings, whether direct or indirect. In addition, electronic communications and notifications may be performed using wired connections, wireless connections, or a combination thereof and may be transmitted directly or through one or more intermediary devices over various types of networks, communication channels, and connections. Moreover, relational terms such as first and second, top and bottom, and the like may be used herein solely to distinguish one entity or action from another entity or action without necessarily requiring or implying any actual such relationship or order between such entities or actions.

As described above, time-related commands in a web page that parse and format dates (including a time, a date, or a combination thereof) apply the local time zone of the browser application displaying the web page, which is typically set based on the local time zone of the computing device (operating system) executing the browser application. Thus, the results of such time-related commands differ based on the local time zone used by the browser application displaying the web page. For example, if a web page includes the JavaScript command “new Date (2018, 1, 15, 1, 2, 3).toString( )” and is displayed on a computing device running in the Pacific Standard time zone, the web page displays “Thu Feb. 15 2018 01:02:03 GMT-0800 (Pacific Standard Time).” However, if the same web page is displayed on a computing device running in the Eastern Standard time zone, the web page displays “Thu Feb. 15 2018 01:02:03 GMT-0500 (Easter Standard Time).” Thus, not only are the resulting string different, but the primitive values (extracted via a valueOf( ) function call) of the components of such dates have different values even though they were constructed with exactly the same parameters.

As also described above, adopting the local time zone of the browser application for each web page displayed by the browser application may provide confusing or inefficient information to a user. For example, displaying a calendar in a local time zone may make it difficult for a user to schedule a meeting with respect to a different time zone. Accordingly, embodiments described herein allow web pages (including web applications that manipulate dates in user-specified time zones such as web-based calendaring applications) to specify a time zone that should be used when dates are constructed, parsed, and displayed within the web page so that the web page can operate independent of the local time zone. Setting the time zone also allows the web page to continue to leverage time-related commands and data available through the browser application (and the operating system) without requiring complex time conversion logic to be hardcoded into the web page.

It should be understood that time-related information, as described in the present application, includes time information (5:45:00 PM EST), date information (Mar. 1, 2018), or a combination thereof (5:45:00 PM EST Mar. 1, 2018). Also, as used in the present application, the term “web page” includes an electronic document that can be displayed via a browser application and may be a page provided as part of a web-based application or service. Furthermore, in some embodiments, the functionality described herein may be used outside of the context of a web page. For example, a software application other than a browser application may be configured to interpret or execute markup language code or scripting language code included in an electronic document and, thus, may be configured to set a time zone as described herein that may be different from the time zone of the computing device executing the application.

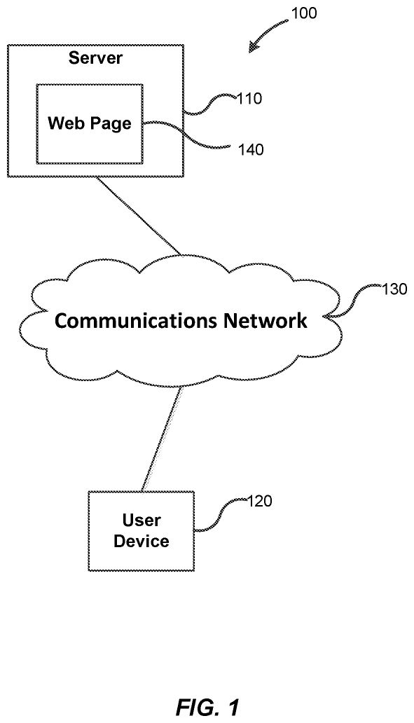

FIG. 1 schematically illustrates a system 100 for displaying a web page. As illustrated in FIG. 1, the system 100 includes a server 110 and a user device 120. It should be understood that the system 100 is provided as an example and, in some embodiments, the system 100 may include additional components. For example, the system 10 may include multiple servers 110, multiple user devices 120, or a combination thereof.

The server 110 and the user device 120 are communicatively coupled via a communications network 130. The communications network 130 may be implemented using a wide area network, such as the Internet, a local area network, such as a Bluetooth™ network or Wi-Fi, a Long Term Evolution (LTE) network, a Global System for Mobile Communications (or Groupe Special Mobile (GSM)) network, a Code Division Multiple Access (CDMA) network, an Evolution-Data Optimized (EV-DO) network, an Enhanced Data Rates for GSM Evolution (EDGE) network, a 3G network, a 4G network, and combinations or derivations thereof. In some embodiments, rather than or in addition to communicating over the communications network 130, the server 110 and user device 120 may communicate over one or more dedicated (wired or wireless) connections. In addition, in some embodiments, the server 110 and the user device 120 may communicate over one or more intermediary devices, such as routers, servers, gateways, relays, and the like.

The server 110 hosts (stores in a computer-readable medium) a web page 140. In some embodiments, the server 110 hosts multiple web pages. The web page 140 includes code written in a markup language, such as Hypertext Markup Language (“HTML”), that a browser application reads or interprets. Markup languages, such as HTML, use tags to define elements of the web page 140 (a body section where content is displayed) as well as metadata of the web page 140, such as the particular markup language or version used to create the web page 140, a title of the web page 140, an author of the web page 140, a description of the web page 140 (used by search engines), and the like. In some embodiments, the web page 140 also includes code written via a stylesheet language, such as Cascading Style Sheets (“CSS”), that defines how the content defined by the markup language is to be displayed (layout, color, font, and the like).

The web page 140 may also include one or more scripts or programs written via one or more programming languages, such as JavaScript, PHP, and Perl, that allow the web page 140 to be interactive. In other words, as compared to defining or formatting content displayed within the web page 140 (via HTML or CSS code), these scripts allow the web page 140 to be interactive, such as by receiving input from a user and responding to user input.

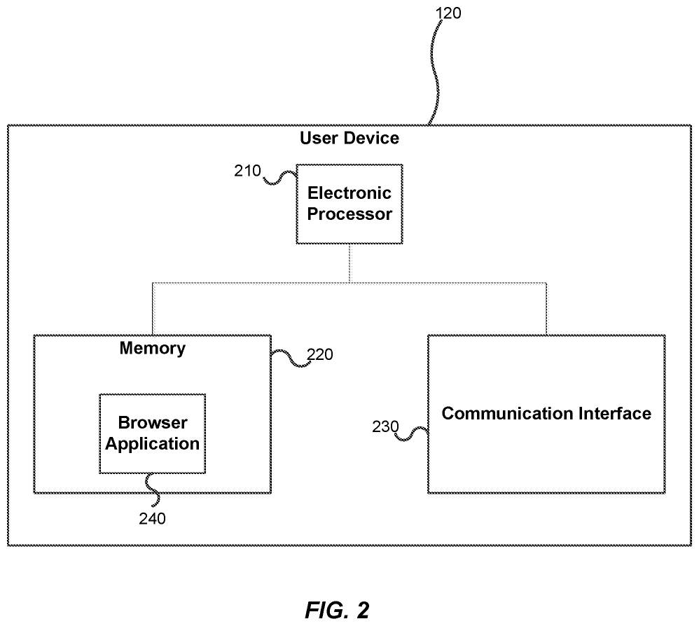

Browser applications executed by user devices request the web page 140 from the server 110 via the communications network 130. For example, FIG. 2 schematically illustrates the user device 120 in more detail. The user device 120 is a personal computing device (for example, a desktop computer, a laptop computer, a terminal, a tablet computer, a smart telephone, a wearable device, or the like). As illustrated in FIG. 2, the user device 120 includes an electronic processor 210, a memory 220, and a communication interface 230. The electronic processor 210, the memory 220, and the communication interface 230 communicate over one or more communication lines or buses, wirelessly, or a combination thereof. In some embodiments, the user device 120 includes additional components than those illustrated in FIG. 2 and the components included in the user device 120 may arranged in various configurations, such as multiple electronic processors 210, multiple memory devices 220, multiple communication interfaces 230, or a combination thereof. For example, in some embodiments, the user device 120 also includes one or more human machine interfaces, such as a display, a touchscreen, a keyboard, a keypad, a cursor-control device, and the like. The user device 120 may also perform additional functionality than the functionality described herein.

The electronic processor 210 may include a microprocessor, application-specific integrated circuit (ASIC), or another suitable electronic device. The electronic processor 210 is configured to retrieve instructions from the memory 220 and execute the instructions to perform, among other things, the processes and methods described herein. The memory 220 may also store data used by or generated by the electronic processor 210 as part of executing instructions. The memory 220 includes a non-transitory, computer-readable storage medium. The communication interface 230 allows the user device 120 to communicate with external devices or networks. For example, in some embodiments, the communication interface 230 includes a transceiver (for example, a Wi-Fi or Ethernet transceiver) for communicating over the communications network 130 and, optionally, one or more additional wired or wireless communication networks or connections.

As illustrated in FIG. 2, the memory 220 stores a browser application 240. As described above, the browser application 240 allows the user device 120 to retrieve the web page 140 from the server 110 and display the web page 140 on a display of the user device 120. The browser application 240 is configured to interpret the markup and stylesheet code included in the web page 140 to display the web page 140. The browser application 240 also includes an engine for executing scripts included in the web page 140.

As described above, when a browser application receives and displays a web page, the browser application applies the time zone of the browser application (sometimes referred to herein as a local time zone), which typically is the time zone of the device executing the browser application. The local time zone is stored in memory of the user device and may be set by a user or may be automatically set by the operating system based on received location information. Thus, a browser application may access the stored local time zone when interpreting web pages and applying the time zone to time-related information and commands included in a web page. For example, in some embodiments, when a browser application is launched, the browser application may access the stored local time zone (directly or through the operating system) and set a configuration variable of the browser application to the local time zone.

Accordingly, although scripting code, such as JavaScript, may provide one or more application programming interfaces (“APIs”) or functions for constructing, parsing, and displaying time-related information, the APIs and functions are performed with respect to the local time zone of the browser application and, hence, may not be useful for a web page that allows a user to specify or select a desired time zone or otherwise makes use of a time zone different from the local time zone.

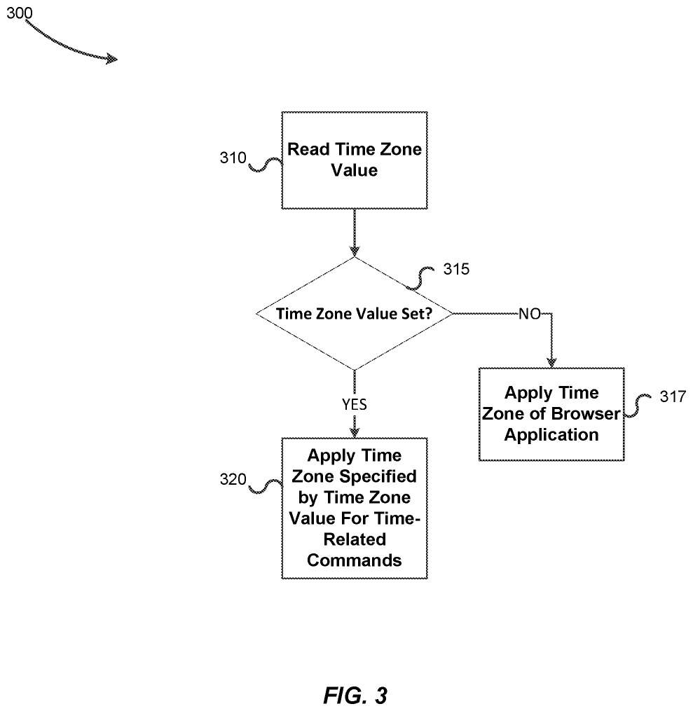

Thus, to solve these and other problems with existing web pages, the browser application 240 included in the user device 120 is configured to allow the web page 140 to set a time zone for the web page 140, which may be different than the time zone of the browser application 240 and the time zone of the user device 120 (as set by the operating system of the user device 120). For example, FIG. 3 illustrates a method 300 of providing a per-web-page time zone according to one embodiment. The method 300 is described as being performed by the browser application 240 (as executed by the electronic processor 210) when interpreting a web page 140 for display on the user device 120 (on a display or touchscreen). However, it should be understood that the functionality described herein as being performed by the browser application 240 (or a portion thereof) may be performed by other software applications, such as an operating system of the user device 120, an add-in for the browser application 240, or another intermediary software application that interfaces with the browser application 240. For example, the browser application 240 may leverage time zone information (such as time zone tables defining time offsets) maintained by the operating system to convert time-related data to a particular time zone.

As illustrated in FIG. 3, the method 300 includes reading a time zone value from code included in the web page 140 (at block 310). In some embodiments, the web page 140 may define the time zone within metadata of the web page 140. For example, the following HTML code illustrates a sample metadata header tag included in the web page 140 for defining the time zone value according to one embodiment.

```
<html>
  <head>
    <meta name=“timezone” value=“America/New York”/>
    . . .
  </head>
  . . .
</html>
```

Alternatively, scripting code included in the web page 140 may set the time zone for the web page 140 by invoking a pre-defined global API and passing an identifier of a time zone to be used. For example, setting the time zone via scripting code may take the form of a function call as illustrated by the below sample code.

setTimeZone(“Eastern Standard Time”)

Similarly, setting the time zone via scripting code may take the form of setting of a field, such as, for example, in the global (or document) namespace as illustrated below.

global.timeZone=“Eastern Standard Time”

It should be understood that the time zone may be hardcoded within the web page 140 or may be set dynamically, such as by a user (through a prompt, a drop-down menu, a radio selection button, or the like) when the web page 140 is displayed. Accordingly, the above example tags, function calls, and fields may reference a dynamically-set variable in place of a static value as illustrated. In addition, it should be understood that the above mechanisms for setting the time zone of the web page 140 are provided as examples and a time zone may be set for the web page 140 using different mechanisms, objects, interfaces, syntaxes, or the like.

Returning to FIG. 3, when the time zone value has not been set or has no or an invalid value (for example, a tag or field is null or empty or refers to an undefined time zone) (at block 315), the browser application 240 uses a local time zone of the browser application (which may be stored or set in memory, such as the memory 220 or a separate memory) for time-related commands included in the web page 140, such as JavaScript commands for constructing, parsing, and displaying time-related information (at block 317).

Alternatively, when the time zone value is set (at block 315), the browser application 240 uses the specified time zone value for time-related commands included in the web page (at block 320). For example, when the web page 140 includes code “new Date (2018, 1, 15, 1, 2, 3).toString( )” and the web page 140 set the time zone to Eastern Standard Time, this command yields a value of “Thu Feb. 15 2018 01:02:03 GMT-055 (Eastern Standard Time)” regardless of whether the local time zone of the browser application is in Pacific Standard Time, Central Standard Time, or another time zone different than Eastern Standard Time. In some embodiments, the browser application 240 applies the web-page-specific time zone by initially responding to such commands per the local time zone and then converting the response to the web-page specific time zone. Thus, the time zone conversion is performed by the browser application 240 (which may already have access to time zone information, such as time zone offsets available via the operating system) without requiring complex specific code in the web page 140 to perform the conversion. Rather, the web page 140 sets the time zone (for example, once) and then makes time-related commands per usual while allowing the browser application 240 (JavaScript engine) to apply the specified time zone. Also, setting the time zone for the web page 140 does not change the local time zone of the browser application 240 or the user device 120, which allows other web pages and other software applications to continue to use the local time zone as needed.

Thus, embodiments described herein provide systems and methods for providing a per-web-page time zone. The systems and methods allow a specific web page to set and apply a time zone independent from the local time zone of the browser application and the computing device executing the browser application while still leveraging time-related commands executable by the browser application. It should be understood that a web page may set a time zone once and have the time zone applied for all time-related commands included in the web page and, optionally, related web pages, such as web pages provided from the same server or provided within the same web application. Also, in some embodiments, a web page 140 may update or cancel the set time zone as needed. Furthermore, it should be understood that, when a browser application has multiple web pages open (such as on separate tabs within the browser application), the time zone set by one web page may not be applied to other web pages displayed by the browser application, which may use the local time zone or another specific time zone. However, in other embodiments, the time zone set by one web page may be applied to other pages also open within the browser application.

Various features and advantages of some embodiments are set forth in the following claims.

1. An apparatus for providing a per-web-page time zone, the apparatus comprising:
a memory storing a local time zone; and
at least one electronic processor configured to execute a browser application to
read a time zone value included in a web page to be displayed within the browser application, the time zone value specifying a time zone different than the local time zone, and
operate the web-page as if the local time zone were updated to be the time zone specified by the time zone value, wherein operating the web-page as if the local time zone were updated to be the time zone specified by the time zone value includes applying the time zone specified by the time zone value in place of the local time zone for all time-related commands included in the web page executed by the browser application without changing the local time zone to the time zone value included in the web page.

2. The apparatus of claim 1, wherein the time zone value is a first time zone value and wherein the at least one electronic processor is further configured to execute the browser application to read a second time zone value included in a second web page to be displayed within the browser application, the second time zone value specifying a time zone different than the local time zone of the apparatus and the time zone specified by the first time zone value.

3. The apparatus of claim 1, wherein the at least one electronic processor is further configured execute the browser application to apply the local time zone for a time-related command included within a second web page executed by the browser application when the second web page does not include the time zone value.

4. The apparatus of claim 1, wherein the time zone value is set via a metadata tag included in the web page.

5. The apparatus of claim 1, wherein the time zone value is set via a function call included in the web page.

6. The apparatus of claim 1, wherein the time zone value is via a field included in a namespace of the web page.

7. The apparatus of claim 1, wherein the time zone value is set by a dynamic variable set via a user.

8. The apparatus of claim 1, wherein the local time zone is a local time zone of the apparatus.

9. A method of providing a per-web-page time zone, the method comprising:
reading, with at least one electronic processor, a time zone value included in a first web page to be displayed within a browser application, the time zone value specifying a time zone different than a local time zone of the browser application;
operating the web-page as if the local time zone were updated to be the time zone specified by the time zone value, wherein operating the web-page as if the local time zone were updated to be the time zone specified by the time zone value includes applying, with the at least one electronic processor, the time zone specified by the time zone value in place of the local time zone for all time-related commands included within the first web page executed by the browser application without changing the local time zone of the browser application to the time zone value included in the first web page; and
applying, with the at least one electronic processor, the local time zone for a time-related command included within a second web page executed by the browser application when the second web page does not include the time zone value.

10. The method of claim 9, wherein reading the time zone value includes reading a metadata tag included in the first web page.

11. The method of claim 9, wherein reading the time zone value includes executing a function call included in the first web page.

12. The method of claim 9, wherein reading the time zone value includes reading a field included in a namespace of the first web page.

13. A non-transitory, computer-readable medium comprising instructions that, when executed by one or more electronic processors, performs a set of functions comprising:
reading a time zone value included in a first web page to be displayed within a browser application, the time zone value specifying a time zone different than a local time zone;
operating the web-page as if the local time zone were updated to be the time zone specified by the time zone value, wherein operating the web-page as if the local time zone were updated to be the time zone specified by the time zone value includes applying the time zone specified by the time zone value in place of the local time zone for all time-related commands within the first web page executed by the browser application without changing the local time zone to the time zone value included in the first web page; and
applying the local time zone for a time-related command included within a second web page executed by the browser application when the second web page does not include the time zone value.

14. The non-transitory, computer-readable medium of claim 13, wherein the time zone value is a first time zone value and wherein the set of functions further includes reading a second time zone value included in a third web page to be displayed within the browser application, the second time zone value specifying a time zone different than the local time zone and the time zone specified by the first time zone value, and applying the time zone value specified by the second time zone value for a time-related command included in the third web page executed by the browser application.

15. The non-transitory, computer-readable medium of claim 13, wherein the first web page is displayed in a first tab of the browser application and the second web page is displayed in a second tab of the browser application.

16. The non-transitory, computer-readable medium of claim 13, wherein reading the time zone value includes reading a metadata tag included in the first web page.

17. The non-transitory, computer-readable medium of claim 13, wherein reading the time zone value includes executing a function call included in the first web page.

18. The non-transitory, computer-readable medium of claim 13, wherein reading the time zone value includes reading a field included in a namespace of the first web page.

19. The non-transitory, computer-readable medium of claim 13, wherein reading the time zone value includes determining a value of a dynamic variable.

20. The non-transitory, computer-readable medium of claim 13, wherein the local time zone is a local time zone of an operating system.
